(19) United States
(12) Patent Application Publication
(10) Pub. No.: US 2026/0135970 A1
(43) Pub. Date: May 14, 2026

(54) WEB-BASED XR MEMO AND VIDEO CONFERENCING SYSTEM FOR FACILITY MANAGEMENT AND WORK SUPPORT AND OPERATING METHOD THEREOF

(71) Applicant: TSP XR, Nowon-gu (KR)

(72) Inventors: Chi Seo JEONG, Nowon-gu (KR); Jin Kyu KANG, Yongsan-gu (KR)

(21) Appl. No.: 19/021,524

(22) Filed: Jan. 15, 2025

(30) Foreign Application Priority Data
Nov. 12, 2024 (KR) 10-2024-0160226

(51) Int. Cl. H04N 7/15; G06T 13/40; G06T 19/00

(52) U.S. Cl. CPC H04N 7/157; G06T 13/40; G06T 19/006; H04N 7/152

(57) ABSTRACT

A web-based XR memo and video conferencing system for facility management and work support includes a host terminal and a server which provides data generated in the host terminal to a plurality of client terminals. The host terminal includes an image data acquisition unit which acquires video data in real time through an embedded camera or an external camera, an XR content augmentation unit which recognizes a marker or a specific object included in the video data and matches and augments an XR content associated with the video data to generate synthesized video data, and a memo event processor which generates memo data based on the input of a user, and the server receives the synthesized video data and the memo data generated in the host terminal and streams and synchronizes the data with the plurality of client terminals in a web-based environment in the real time.

### CROSS-REFERENCE TO RELATED APPLICATIONS

This application claims the benefit of and priority to Korean Patent Application No. 10-2024-0160226 filed on Nov. 12, 2024, in the Korean Intellectual Property Office, the entire disclosure of which is incorporated herein by reference.

### BACKGROUND

### Field

The present disclosure relates to a web-based XR memo and video conferencing system for facility management and work support and an operating method thereof, and more particularly, to a system which combines and streams video data and an XR content in real time by utilizing an extended reality (XR) technique in a web-based environment to support facility management and work collaboration and improve the efficiency of information recording and sharing through a memo function.

### Description of the Related Art

Industrial sites are configured by large-scale facilities and complex work environments, and facility downtime may result in enormous economic losses. Abnormal downtime of major facilities not only reduces productivity but may also lead to safety issues, so that regular inspection and maintenance of facilities are essential. To this end, workers in many industrial sites perform visual inspections to check the condition of facilities, but existing technologies and management methods have several limitations.

First, in the most industrial sites, facility-related data is stored as analog type documents. Data, such as design drawings, drawings, inspection logs, diagnostic records, and history information are managed by paper documents, which makes it difficult to access information. It is difficult for workers to immediately check the information on-site, which delays inspection work and needs a lot of time to search through documents. The analog method is prone to data omission or duplication, and real-time information sharing is impossible, reducing work efficiency.

Second, during the inspection process, the worker should manually record the inspection results in an inspection log. This manual method is not only time-consuming to write and manage, but may also reduce the accuracy of the records. Manually written data is also more likely to cause additional errors during the digitization process. Further, the manually written inspection results are not immediately shared, which may cause the delay of collaboration and communication with the manager.

Third, even if a problem is discovered during the facility inspection, it is difficult to immediately solve the problem onsite. When the problem occurs, it must be reported to a superior authority to be verified and approved by the manager, but this process takes a considerable amount of time. Further, additional documentation or photos need to be provided to explain the problem situation, which reduces speed and accuracy. Real-time collaboration with remote experts or managers is difficult, which inevitably lengthens the time taken to resolve problems.

Fourth, existing video conferencing systems and collaboration tools do not meet the special requirements of industrial sites. General video conferencing systems are limited to simple sharing of video and voice data, and are not integrated with XR (extended reality) technique required for facility management. Further, most systems require installation of specific software or hardware, which results in high initial setup costs and poor user convenience.

In order to solve this problem, a new system is needed to integrally provide real-time information access, data digitization, and collaboration functions.

### SUMMARY

An object of the present disclosure is to combine and share video data and an XR content in real time during facility management and work collaboration to intuitively and accurately transmit information required for facility state and maintenance operation, increase the collaboration efficiency by the memo and recording function, and provide usage convenience in various devices through a web-based system without installing software.

In order to achieve the above-described object, a first aspect of the present disclosure, relates to a web-based XR memo and video conferencing system for facility management and work support. The system includes a host terminal and a server which provides data generated in the host terminal to a plurality of client terminals. The host terminal includes: an image data acquisition unit which acquires video data in real time through an embedded camera or an external camera; an XR content augmentation unit which recognizes a marker or a specific object included in the video data and matches and augments an XR content associated with the video data to generate synthesized video data; and a memo event processor which generates memo data based on the input of a user, and the server receives the synthesized video data and the memo data generated in the host terminal and streams and synchronizes the data with the plurality of client terminals in a web-based environment in the real time.

According to an exemplary embodiment of the present disclosure, the host terminal may include a session manager which maintains a connection state between users by means of session management and sets and manages a real-time data transmission path.

According to an exemplary embodiment of the present disclosure, the host terminal may include a peer connection manager which adjusts real-time data transmission so as to synchronize the video data, the XR content, and the memo data with the client terminal.

According to an exemplary embodiment of the present disclosure, the host terminal may include a visualization module which visually integrates the memo data and the XR content to output the integrated memo data and XR content to the user through a display of the host terminal.

According to an exemplary embodiment of the present disclosure, the XR content augmentation unit automatically may select and match a previously stored XR content based on a marker or a specific object which is defined in advance in the host terminal.

According to an exemplary embodiment of the present disclosure, the XR content may include at least one of a 3D model, an augmented reality (AR) animation, a virtual reality (VR) element, or a mixed reality (MR) content.

According to an exemplary embodiment of the present disclosure, the XR content augmentation unit augments an XR guide for maintenance or assembly of the object by recognizing the specific object to be included in the synthesized video data.

According to an exemplary embodiment of the present disclosure, the server may include: a session traversal utilities for NAT (STUN) server which identifies a public IP address of each terminal in a network address translation (NAT) environment to set a network connection between the host terminal and the client terminal and evaluates P2P connection possibility; and a traversal using relays around NAT (TURN) server which operates as a relay server when the direct connection between the host terminal and the client terminal is not possible to guarantee the stability of the data streaming.

According to an exemplary embodiment of the present disclosure, the server may include a signaling server which exchanges a control signal for session management between the host terminal and the client terminal to set WebRTC based real-time communication.

According to an exemplary embodiment of the present disclosure, the server may include a database unit which manages the video data, the XR content, and the memo data received from the host terminal to be stored in the time sequence and if necessary, to be searched and reproduced.

According to an exemplary embodiment of the present disclosure, the client terminal may include a second memo event processor which outputs the synthesized video data and the memo data received from the server in real time and generates memo data based on user input.

According to an exemplary embodiment of the present disclosure, the client terminal includes a capture interface which captures the synthesized video data including the memo data, and the captured video data is transmitted to the server to be stored.

In order to achieve the above-described object, a second aspect of the present disclosure, relates to an XR memo and video conferencing system operating method using a web-based XR memo and video conferencing system for facility management and work support. The system includes a host terminal and a server which provides data generated in the host terminal to a plurality of client terminals, and the method may include a) a step of acquiring video data in real time through an embedded camera or an external camera; b) a step of generating synthesized video data by recognizing a marker or a specific object included in the video data and matching and augmenting an XR content associated with the video data; c) a step of generating memo data based on input of a user; and d) a step of receiving the synthesized video data and memo data and streaming and synchronizing the data with the plurality of client terminals in a web-based environment in real time.

According to an exemplary embodiment of the present disclosure, in the step b), a previously stored XR content based on a marker or a specific object which is defined in advance may be automatically selected and matched.

According to an exemplary embodiment of the present disclosure, the step b) may include a step of augmenting an XR guide for maintenance or assembly of the object by recognizing the marker or the specific object to be included in the synthesized video data.

According to an exemplary embodiment of the present disclosure, the step c) may include a step of visually integrating the memo data and the XR content to output the integrated memo data and XR content to the user through a display of the host terminal.

According to an exemplary embodiment of the present disclosure, the step d) may include a step of managing the video data, the XR content, and the memo data received from the host terminal to be stored in the time sequence and if necessary, to be searched and reproduced.

According to an exemplary embodiment of the present disclosure, the method may further include a step e) of transmitting the captured synthesized video data to the server to be stored when the synthesized video data including the memo data is captured by a capture interface.

According to the present disclosure, the web-based XR memo and video conferencing system may improve real-time collaboration between users. This system integrates and streams video data, an XR content, and memo data in real time to allow the users to cooperate based on visual and intuitive information. Specifically, complex facility structure or maintenance procedures can be easily understood by means of the XR content, which increases accuracy and efficiency of the task.

Another advantage of the present disclosure is that the system operates based on the web to be used only with the web browser, without installing separate software. Accordingly, the platform independence and accessibility are guaranteed, and the system may be easily used in various devices, which reduces the burden on the company's IT infrastructure. Further, a memo which is written by the user during the conference is stored in a server in real time and is immediately shared with the other users to support the smooth collaboration.

Specifically, the memo function is a function which allows the user to directly input data on the screen to display a specific position or write additional information and the memo is synchronized in real time to allow all participants to see the same content. This function is very useful to quickly share the problems of the facility and discuss the solutions.

Further, this system stores all data generated during the conference in the time sequence to manage the data to be searched and reproduced thereafter. Therefore, the conference records are systematically managed and are utilized as a reference if necessary, to strengthen continuity and responsibility of the work. Finally, a capture function of the present disclosure captures and stores the synthesized video data and memo data in real time to provide a function for storing important information without missing the important information. By doing this, the accuracy and the reliability of the information are increased and it is utilized as work report writing or proof materials.

The effects of the present disclosure are not limited to the aforementioned effects, and other effects, which are not mentioned above, will be apparently understood to a person having ordinary skill in the art from the following description.

The objects to be achieved by the present disclosure, the means for achieving the objects, and the effects of the present disclosure described above do not specify essential features of the claims, and, thus, the scope of the claims is not limited to the disclosure of the present disclosure.

### BRIEF DESCRIPTION OF DRAWINGS

The above and other aspects, features and other advantages of the present disclosure will be more clearly understood from the following detailed description taken in conjunction with the accompanying drawings, in which:

FIG. 1 is a view illustrating an overall system structure of a web-based XR memo and video conferencing system according to the present disclosure;

FIG. 2 is a video conference flowchart of a web-based XR memo and video conferencing system according to the present disclosure;

FIG. 3 is a view illustrating a real-time streaming system structure between a host terminal and a server, according to the present disclosure;

FIG. 4 is a view illustrating a synthesizing process of video data and XR contents in real time, according to the present disclosure;

FIG. 5 is a view illustrating a memo writing and synchronizing system structure according to the present disclosure; and,

FIG. 6 is a view illustrating a screen on which an XR memo function according to the present disclosure is implemented.

### DETAILED DESCRIPTION OF THE EMBODIMENT

Hereinafter, the exemplary embodiment of the present disclosure will be described with reference to the accompanying drawings and exemplary embodiments as follows. Scales of components illustrated in the accompanying drawings are different from the real scales for the purpose of description, so that the scales are not limited to those illustrated in the drawings.

Specific contents for implementing the present disclosure will be described in detail with reference to the following accompanying drawings. In addition, when explaining the present invention, if it is judged that the relevant known functions are obvious to those skilled in the art and may unnecessarily obscure the gist of the present invention, a detailed description thereof will be omitted.

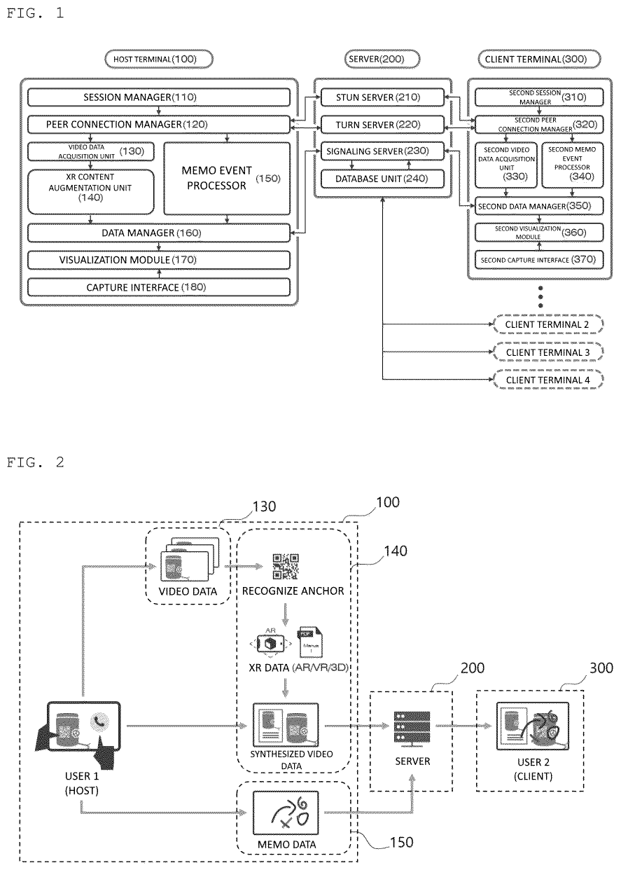

FIG. 1 is a view illustrating an overall system structure of a web-based XR memo and video conferencing system according to the present disclosure and FIG. 2 is a video conference flowchart of a web-based XR memo and video conferencing system according to the present disclosure.

Referring to FIGS. 1 and 2, the web-based XR memo and video conferencing system according to the present disclosure includes a host terminal 100 and a server 200 which provides data generated in the host terminal 100 to a plurality of clients 300.

The host terminal 100 may include a session manager 110, a peer connection manager 120, an image data acquisition unit 130, an XR content augmentation unit 140, a memo event processor 150, a data manager 160, a visualization module 170, and a capture interface 180.

The server 200 may include an STUN server 210, a TURN server 220, a signaling server 230, and a database unit 240.

Hereinafter, configurations of the host terminal 100 will be described first, and then the server 200 will be described.

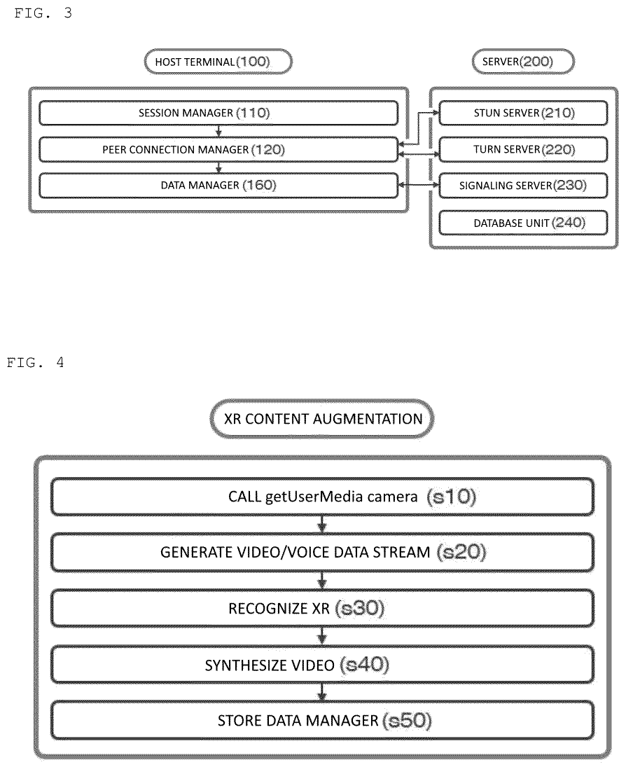

FIG. 3 is a view illustrating a real-time streaming system structure between a host terminal and a server, according to the present disclosure.

Referring to FIG. 3, the session manager 110 and a peer connection manager 120 of the host terminal 100 will be described first as follows.

The session manager 110 serves to set, manage, maintain, and terminate a WebRTC based session for real-time data transmission in the host terminal 100. This session provides a communication path to efficiently transmit and receive various data, such as video data, XR contents, or memo data. The session manager 110 sets an initial session between the host terminal 100 and the client terminal 300 through the signaling server 230. To this end, session description protocol (SDP) information of each terminal is exchanged and an optimal P2P connection path is searched through an interactive connectivity establishment (ICE) process.

The session manager 110 manages various types of sessions. A video data session transmits a real-time image acquired through the camera of the host terminal 100 to the client terminal 300 and the XR content session synchronizes augmented reality data generated in the host terminal 100 to stream the augmented reality data to the client terminal 300. Further, the memo data session helps to share the memo data input by the user with another terminal in real time.

The session manager 110 consistently monitors a session connection status to evaluate a network quality. When a P2P connection is unstable or impossible, the session manager 110 sets a relay connection using the TURN server 220 to maintain the stability of the data transmission. When the video conference ends or a session is no longer needed, the session manager safely terminates all connections and cleans up associated resources.

The session manager 110 uses this function to operate as a configuration which efficiently manages a data transmission path of the system and provides a stable real-time collaborative environment.

The peer connection manager 120 is a configuration which sets and maintains P2P connection between the host terminal 100 and the client terminal 300. The peer connection manager operates based on the WebRTC technique and guarantees stable P2P connection even in a network address translation (NAT) environment through linkage with a session traversal utilities for NAT (STUN) server 210 and a traversal using relays around NAT (TURN) server 220.

The peer connection manager 120 serves to control and manage real-time data transmission between the host terminal 100 and the client terminal 300. The peer connection manager 120 is based on the WebRTC technique and sets peer-to-peer (P2P) connection to efficiently transmit all real-time data including video data, voice data, XR contents, and memo data.

The peer connection manager 120 uses an ICE protocol to set P2P connection in the NAT environment, first. By doing this, a public IP address and a port of each terminal are identified by utilizing the STUN server 210 and if necessary, the relay connection is set by means of the TURN server 220. By doing this, even though the direct connection between terminals is not possible, stable data transmission is possible.

The peer connection manager 120 communicates with the signaling server 230 through the data manager 160 to exchange signaling information. The signaling server 230 serves to exchange SDP and ICE candidate information required to set the P2P connection. The peer connection manager sets the connection with the client based on this information and generates a data stream to transmit real-time data.

During the data transmission process, the peer connection manager 120 maintains data synchronization between all users. By doing this, the video data and the XR contents are shared in real time and memos created by the individual users are immediately reflected to screens to the other users. A memo-associated configuration will be described below.

The peer connection manager 120 consistently monitors the network status to manage the quality of the connection and if necessary, sets an alternate path to maintain stable data transmission. These functions support smooth operation of the real-time XR based video conferencing system and provide users with an uninterrupted collaboration environment.

FIG. 4 is a view illustrating a synthesizing process of video data and XR contents in real time, according to the present disclosure.

Referring to FIG. 4, the video data acquisition unit 130 and an XR content augmentation unit 140 of the host terminal 100 will be described as follows.

The video data acquisition unit 130 serves to acquire real-time video data from a camera of the host terminal 100 or the client terminal 300 or an external camera and transmit the real-time video data to the other module in the system. The video data acquisition unit 130 is designed to operate in a web-based environment and immediately operates through a browser without installing additional software. The video data acquisition unit accesses a camera or a microphone using an API, such as getUserMedia, based on the WebRTC technique in step s10. By doing this, video/voice data streams including a face, voice, and surrounding environments of the user are generated in real time in step s20.

The XR content augmentation unit 140 is a key module which combines the video data and the XR content in the present disclosure and recognizes a marker or a specific object in the video data and augments an XR content suitable therefor to provide the user with augmented reality experience. This process is generally configured by object recognition, XR content matching and generation, and real-time synthesis with video data.

First, the XR content augmentation unit 140 analyzes video data transmitted from the video data acquisition unit 130 to search for a specific marker and a specific object to detect a recognition target in step s30. The markers are set according to a previously defined criterion and for example, may be a QR code, a specific pattern, or a specific object. At this time, when the recognition target is detected, the XR content augmentation unit 140 identifies the recognition target to automatically select and match the XR content corresponding to the object or the marker.

The XR content according to the recognized marker or the specific object is stored in the data manager 160 of the host terminal 100 or the database unit 240 of the server 200 and may include at least one of a 3D model, an augmented reality (AR) animation, a virtual reality (VR) element, or a mixed reality (MR) content. The XR content augmentation unit 140 selects a content suitable for the detected object, and for example, displays 3D AR guide for facility maintenance or an assembling instruction of a specific component. The content selection and matching process is performed in real time to quickly provide the user with the augmented content.

The XR content augmentation unit 140 synthesizes the selected XR content with the video data in step s40. At this time, the XR content augmentation unit 140 adjusts the spatial position and the size to accurately combine the real-time video data captured by the camera and the selected XR content to allow the user to see the content which is augmented in the actual environment through the screen.

The video data synthesized as described above is stored in the data manger 160 of the host terminal 100 in step s50. The data manager 160 transmits the synthesized video data to the server 200 to be streamed to the client terminal 300 or displayed on the display of the host terminal 100.

In the meantime, if necessary, the XR content augmentation unit 140 includes an element which is interactive with the user and may further adjust a motion or an interaction of the content in accordance with the input of a touch or a gesture.

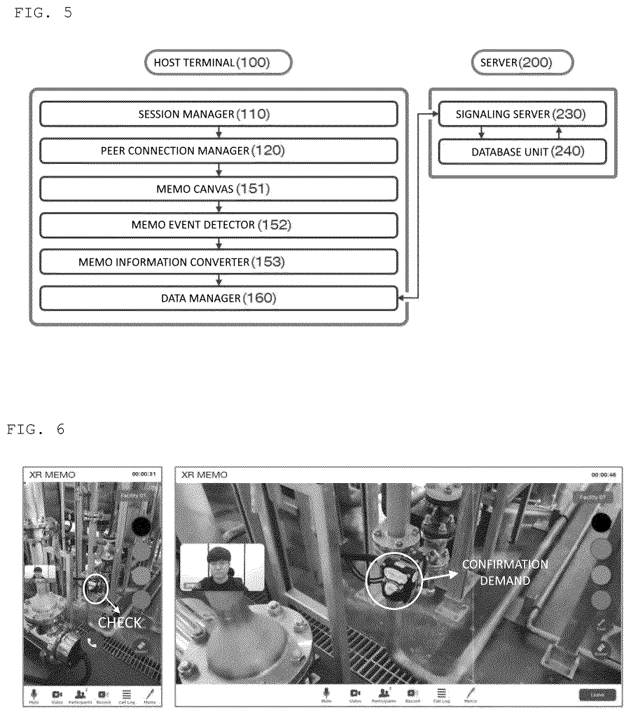

FIG. 5 is a view illustrating a memo writing and synchronizing system structure according to the present disclosure.

Referring to FIG. 5, the memo event processor 150 serves to process the user input in real time to generate memo data and share the memo data with the other user or store the memo data in a server. The memo event processor 150 operates based on the HTML5 Canvas API and allows the user to directly write a memo on the screen using a touch screen, a mouse, or a stylus. The memo input by the user is immediately visualized on the screen and the memo event detector tracks the input event in real time to collect data.

While the user inputs something on the screen, a memo canvas 151 immediately visualizes the input content to provide a real-time feedback. When the user draws a line or adds a text, the memo canvas renders the line or the text and the memo event detector is activated based on the input event. The memory event detector 152 tracks input operations (for example, line drawing, erasing, text input, or the like) in real time and collects the input data. This data includes visual properties of the memo, such as its position, a size, a color, a line thickness, and an input path.

The detected input data is converted into a JSON format in a structured manner through the memo information converter 153 and a timestamp is added thereto to record the memo writing time and order. The time stamp is essential to manage and synchronize the memo data and allows the writing time of the memo written by the user to be clearly confirmed. The JSON format memo data created as described above is transmitted to the server through the data manager 160.

The server 200 synchronizes the memo data with the plurality of client terminals 300 in real time through the signaling server 230. During this process, all participants immediately check the same memo content. Further, the memo data is stored in the database unit 240 of the server to be accessible even after the meeting ends. The stored memos are aligned in the time sequence to be utilized to review the meeting content or write a report if necessary.

The memo event processor 150 updates a screen of the client terminal in real time to improve the user's experience and allows the user to immediately check the memo writing result in a synchronized state with the other participant. Further, the user may utilize a screen capturing function during the meeting to store the current state and make an additional annotation on the captured screen. This function efficiently supports the real-time collaboration and data sharing in the complex work environment to increase accuracy of the information transmission and improve the work efficiency.

The data manager 160 plays a key role to collect, process, and transmit various data in the system. The data manager 160 maintains data consistency between the users and supports smooth streaming in the real-time collaboration environment by integrating video data, XR content, and memo data.

First, the data manager 160 collects data from the video data acquisition unit 130, the XR content augmentation unit 140, the memo event processor 150 of the host terminal 100. The video data is a video which is captured in real time and the XR content is augmented reality information which is synthesized with the video data. The memo data is a text or drawing content which is converted into a JSON format based on the user's input. Data collected as described above is integrated and managed by the data manager 160 and is prepared for real-time streaming and synchronization.

The data manager 160 serves to integrate various data which is collected and processed in the host terminal 100 and transmit the various data to the server 200. This data is processed and relayed in the server to be transmitted to the client terminal 300. Further, the data manager 160 provides a temporary storing function and when the data connection is unstable, may temporally store the data in the local. Thereafter, when the network becomes stable, the stored data is transmitted to the server to maintain the consistency of the data.

The visualization module 170 is a component which visually provides the user with various data and serves to output synthesized video data and XR content, and the memo data to the screen in real time. The visualization module 170 helps the user to check the state in which the XR content is naturally augmented in the actual environment. The visualization module 170 provides an intuitive visual feedback to the user interface (UI) based on the data processed in real time and allows the user to quickly understand the current situation and take necessary actions.

First, integrated visualization of the image data and the XR content is achieved. The synthesized image data generated in the image data acquisition unit 130 and the XR content generation unit 140 is transmitted to the visualization module 170. The synthesized image data is output to the user display in real time to display the XR content (for example, a 3D model, an AR animation, or the like) augmented on the real-time video captured by the camera in an accurate position with an accurate size. The visualization module 170 optimizes and renders data in accordance with the user's display environment (a screen size, a resolution, and the like).

Next, real-time visualization of the memo data is performed. The memo data created in the memo event processor 150 is reflected to the screen through the visualization module 170 in real time. When the user writes or edits the memo, the memo is instantly displayed on the screen and the same memo is simultaneously displayed on the client terminal 300 through the synchronization with the other user. During this process, the visualization module 170 maintains visual properties, such as a position, a size, a color, and a line thickness of the memo and provides the user with intuitive interface.

A capture interface 180 is a component of the host terminal 100 and provides a function of allowing a user to capture and store a screen at a specific timing. The capture interface 180 is designed to allow the user to collectively capture the synthesized image data, XR content, and memo data which are displayed in real time.

The capture interface 180 detects the user input (for example, button clicking or short-cut keyboard) to trigger a screen capture event. When the capture event occurs, XR content, memo data, and real-time video data including all visual elements displayed on the current screen are integrated to be stored as an image format. Such capture data is converted into a standard image format, such as PNG or JPEG and if necessary, is stored in a PDF format to be documented.

The captured data is transmitted to the server 200 through the data manager 160 to be stored as a meeting record. The data is aligned in the database unit 240 of the server 200 in the time sequence and is managed to be searched by the user even after the meeting ends. By doing this, the user may easily review the main contents of a specific meeting or use the recorded data as work reports or proof materials.

Further, the capture interface 180 provides a visual feedback to help the user to immediately perceive that the capture is successfully completed. For example, a short animation or message is displayed on the screen after capturing to inform the user of the captured state.

The capture interface 180 allows the user to quickly record important visual information and share the visual information with team members or review later to assist the user not to miss an important moment and data which occurs during the meeting.

Hereinafter, the STUN server 210, the TURN server 220, the signaling server 230, and the database unit 240 which are configurations of the server 200 will be described.

The STUN server 210 serves to support the P2P connection between the host terminal 100 and the client terminal 300 in the network address translation (NAT) environment. The NAT is mainly used to enhance network security and save IP addresses, but in such NAT environments, it is difficult to set direct P2P connections with the external Internet. In order to solve this problem, the STUN server 210 checks the public IP address and the port information of the terminal and provides information required to set the P2P connection based the information.

The STUN (session traversal utilities for NAT) server 210 supports a terminal located behind the NAT to know which public IP address and port are used at the outside. By doing this, even in the NAT environment, the direct connection between terminals is possible to smoothly perform the real-time communication based on the WebRTC. The STUN server 210 processes connection request and helps each terminal to exchange information required for P2P connection with the opponent.

This process is not limited to simply checking public IP addresses and ports, but also plays an important role in the steps of attempting P2P connections. When the connection between two terminals is set with information provided from the STUN server, the data transmission is directly performed, without passing through the server. By doing this, the standby time is reduced and the data transmission speed is improved to quickly and smoothly operate various functions, such as real-time video conference, XR content streaming, and memo synchronization.

The traversal using relays around NAT (TURN) server 220 is a server which performs the role of data relay to guarantee stable communication when P2P connection is not possible in a NAT (network address translation) environment. In the system of the present disclosure, the TURN server 220 is used as an essential component to smoothly transmit the real-time video data, the XR content, and memo data between the host terminal 100 and the client terminal 300.

Unlike the STUN server 210, when the P2P connection fails due to the NAT and the firewall, the TURN server 220 transmits the data through the relay server. For example, when two terminals are located in different strict NAT environments so that direct connection is not possible, the TURN server 220 receives data as a relay unit and retransmits the data to the opponent terminal. This method solves the P2P connection problem by bypassing the path of the data and significantly improves the stability in the real-time streaming based on the WebRTC.

In order to guarantee the stability of the real-time data transmission, the TURN server 220 is designed to minimize the latency and the packet loss. This server specifically plays an important role to accurately transmit the synchronized memo data to all the clients while maintaining qualities of the video data and the XR content. By utilizing TURN server, the users may seamlessly use real-time video conferencing and collaboration functions without being restricted by NAT environment.

The signaling server 230 is an essential element in the WebRTC based real-time communication and serves to set and manage the connection between the host terminal and the client terminal. The signaling server 230 adjusts an initial connection process and exchanges information required to set a network path for data transmission between two terminals. To this end, interactive connectivity establishment (ICE) candidate information, session description protocol (SDP) data, and network environment information are transmitted to support the P2P connection.

The signaling server 230 also serves to manage the session to track and manage the state of the user sessions. When a new user participates in the session or the existing user leaves, this information is transmitted to all connected terminals in real time to maintain the consistency of the collaboration environment. Specifically, when the connection is disconnected or resetting is necessary due to the unstable network, the signaling server 230 senses this problem and automatically performs a new connection setting process to minimize disruption to the user experience.

Further, the signaling server 230 solves the connection problem in the network address translation (NAT) environment by means of the cooperation with the STUN server 210 and the TURN server 220. During this process, the signaling server exchanges the public IP address and port of each terminal and sets a relay connection through the TURN server 220 if necessary. By doing this, stable and efficient data transmission is possible and the video data, the XR content, and the memo data are synchronized in real time.

The database unit 240 is a key component which collectively stores and manages various types of data generated in the system and is physically implemented as one database server, but logically, is operated to be divided into various data sets. Key data type includes video data, XR contents, memo data, and event logs, user and session management data.

First, the image data stores real-time video streams which are received in the host terminal 100 in a time sequence and supports to search and play the real-time video streams even after the meeting ends. The video data is stored with a high resolution and low resolution versions to be streamed with an appropriate quality according to the network state. By doing this, the users may review the visual materials at any time as needed during the meeting or after the meeting.

Next, the XR contents are configured by a 3D model, an AR animation, and a VR element which operate to be associated with the video data. The database unit 240 stores the XR content which is augmented when the specific marker or object is recognized, in advance, and manages the mapping information to synchronize the contents with the video data. By doing this, the XR contents are utilized in real time during the meeting and the same XR effect may be provided while reproducing the meeting record.

The memo data and the event log store all activities related to the memo written during the meeting. The memo data includes contents of the written memo, writer information, a meeting ID to which the memo belongs, writing and editing time. This data is transmitted to the server in the JSON format to be stored in the database and is aligned in the time sequence to be easily searched. The event logs record key activities that occurred during a meeting, such as user activities such as creating, modifying, or deleting memo, or the entry and exit of participants, allowing for systematic tracking of meeting progress.

Finally, the user and session management data manages information of a user and each meeting session which are stored in the system. The user information includes a user ID, name, e-mail, and an authority level to support authentication and authority management of the user. The session management data includes a unique ID of the meeting session, start and end times, a list of participants, and conference setting to enable stable session maintenance and reconfiguration.

The database unit 240 closely interworks with the signaling server 230 to support the real-time data synchronization and information sharing. For example, when the memo is written or edited during the meeting, the information is synchronized with all participant terminals through the signaling server 230 and is stored in the database unit 240 simultaneously to be accessible thereafter. By doing this, the users may cooperate with each other always by checking the latest data.

Hereinafter, configurations of the client terminal 300 will be described.

The client terminal 300 is configured by various functional modules which communicate with the server 200 in real time and implement a collaborative environment based on video data, XR contents, and memo data.

The client terminal 300 may include a second session manager 310, a second peer connection manager 320, a second video data acquisition unit 330, a second memo event processor 340, a second data manager 350, a second visualization module 360, and a second capture interface 370.

The second session manager 310 manages a session with the server 200 and other terminals in the client terminal 300. The second session manager sets and maintains connection between the user and the server and consistently monitors the connection state. The second session manager provides a session recovery and reconnection function according to the network state change to guarantee a stable conference environment.

The second peer connection manager 320 serves to set and manage the WebRTC based P2P connection. The second peer connection manager provides a stable connection even in the network address translation (NAT) environment through the STUN and TURN servers and optimizes the data transmission to minimize the delay of the video data and the XR contents.

The second video data acquisition unit 330 acquires the video data from the camera of the client terminal 300 in real time to transmit the video data to the server 200. When the user is a host, the data is combined with the XR contents to be utilized as a base for generating synthesized video data.

The second memo event processor 340 generates and manages memo data through the user input (for example, a touch screen or a mouse). The memo which is written, edited, and deleted by the user is converted into the JSON format to be transmitted to the server 200 and synchronized with the other client terminal in real time therethrough. The memo data is integrated with the synthesized video data to be visually output.

The second data manager 350 manages a flow of all data in the client terminal 300. The second data manager processes the synthesized video data and the memo data received from the server to transmit the data to the second visualization module 360 and transmits the user input data to the server 200 to maintain the data consistency in the entire system.

The second visualization module 360 outputs the synthesized video data, the XR contents, and the memo data to the display of the client terminal 300. The second visualization module provides the user with an intuitive and clear visual feedback and renders the 3D model and the AR animation of the XR contents to provide rich collaborative experience.

The second capture interface 370 allows the user to capture the composited video data and the memo data in real time. The captured data is transmitted to the server 200 to be stored in the database unit 240 and is searched and reproduced even after the meeting ends. This is also utilized as a meeting record and proof materials.

FIG. 6 is a view illustrating a screen on which an XR memo function according to the present disclosure is implemented.

Referring to FIG. 6, it is confirmed that the XR content is augmented to be displayed on the user interface together with the real-time video image and various information is added on the screen by utilizing the memo function. The user input is detected by the memo event processor 150 of the host terminal 100 or the second memo event processor 340 of the client terminal 300 and the user may check a specific position of the facility or write a memo on the corresponding position by means of a recognizable pen or touch input.

The memo data is transmitted to the server 200 with the JSON format to be stored in the database 240 and a time stamp and writer information are recorded together. The recorded memo is immediately synchronized with the other client terminal 300 through the server 200 in the web environment so that the other users may check the corresponding memo content in real time. For example, during the maintenance task, a defective part of a specific facility is checked to leave a memo for a brief description about the corresponding problem or a repairing method. The memo is combined with the XR content to provide the user with intuitive and visually understandable information.

Further, the memo function may further facilitate the collaboration during the meeting. A plurality of uses may simultaneously write or edit the memo through the other terminals and all these tasks are synchronized in real time to provide smooth communication between team members. In addition to the memo, the user may capture a screen including the memo and the XR content to be stored in the server 200 and search or review the stored data even after the meeting ends.

The protection scope of this field is not limited to the description or the expression of the exemplary embodiment which has been clearly described above. Further, it is added once again that the protection scope of the present disclosure may not be limited due to obvious changes or substitutions in the technical field to which the present invention belongs.

What is claimed is:

1. A web-based XR memo and video conferencing system for facility management and work support, comprising:
a host terminal; and
a server which provides data generated in the host terminal to a plurality of client terminals,
wherein the host terminal includes:
an image data acquisition unit which acquires video data in real time through an embedded camera or an external camera;
an XR content augmentation unit which recognizes a marker or a specific object included in the video data and matches and augments an XR content associated with the video data to generate synthesized video data; and
a memo event processor which generates memo data based on the input of a user, and
the server receives the synthesized video data and the memo data generated in the host terminal and streams and synchronizes the data with the plurality of client terminals in a web-based environment in the real time.

2. The web-based XR memo and video conferencing system according to claim 1, wherein the host terminal includes a session manager which maintains a connection state between users by means of session management and sets and manages a real-time data transmission path.

3. The web-based XR memo and video conferencing system according to claim 1, wherein the host terminal includes a peer connection manager which adjusts real-time data transmission so as to synchronize the video data, the XR content, and the memo data with the client terminal.

4. The web-based XR memo and video conferencing system according to claim 1, wherein the host terminal includes a visualization module which visually integrates the memo data and the XR content to output the integrated memo data and XR content to the user through a display of the host terminal.

5. The web-based XR memo and video conferencing system according to claim 1, wherein the XR content augmentation unit automatically selects and matches a previously stored XR content based on a marker or a specific object which is defined in advance in the host terminal.

6. The web-based XR memo and video conferencing system according to claim 1, wherein the XR content includes at least one of a 3D model, an augmented reality (AR) animation, a virtual reality (VR) element, or a mixed reality (MR) content.

7. The web-based XR memo and video conferencing system according to claim 1, wherein the XR content augmentation unit augments an XR guide for maintenance or assembly of the object by recognizing the marker or the specific object to be included in the synthesized video data.

8. The web-based XR memo and video conferencing system according to claim 1, wherein the server includes:
a session traversal utilities for NAT (STUN) server which identifies a public IP address of each terminal in a network address translation (NAT) environment to set a network connection between the host terminal and the client terminal and evaluates P2P connection possibility; and
a traversal using relays around NAT (TURN) server which operates as a relay server when the direct connection between the host terminal and the client terminal is not possible to guarantee a stability of a data streaming.

9. The web-based XR memo and video conferencing system according to claim 1, wherein the server includes a signaling server which exchanges a control signal for session management between the host terminal and the client terminal to set WebRTC based real-time communication.

10. The web-based XR memo and video conferencing system according to claim 1, wherein the server includes a database unit which manages the video data, the XR content, and the memo data received from the host terminal to be stored in the time sequence and if necessary, to be searched and reproduced.

11. The web-based XR memo and video conferencing system according to claim 1, wherein the client terminal includes a second memo event processor which outputs the synthesized video data and the memo data received from the server in real time and generates memo data based on user input.

12. The web-based XR memo and video conferencing system according to claim 1, wherein the client terminal includes a capture interface which captures the synthesized video data including the memo data, and the captured video data is transmitted to the server to be stored.

13. An XR memo and video conferencing system operating method using a web-based XR memo and video conferencing system for facility management and work support, wherein the system includes a host terminal and a server which provides data generated in the host terminal to a plurality of client terminals, the operating method comprising:
a) a step of acquiring video data in real time through an embedded camera or an external camera;
b) a step of generating synthesized video data by recognizing a marker or a specific object included in the video data and matching and augmenting an XR content associated with the video data;
c) a step of generating memo data based on input of a user; and
d) a step of receiving the synthesized video data and memo data and streaming and synchronizing the data with the plurality of client terminals in a web-based environment in real time.

14. The operating method of a web-based XR memo and video conferencing system according to claim 13, wherein in the step b), a previously stored XR content based on a marker or a specific object which is defined in advance is automatically selected and matched.

15. The operating method of a web-based XR memo and video conferencing system according to claim 13, wherein the step b) includes a step of augmenting an XR guide for maintenance or assembly of the object by recognizing the marker or the specific object to be included in the synthesized video data.

16. The operating method of a web-based XR memo and video conferencing system according to claim 13, wherein the step c) includes a step of visually integrating the memo data and the XR content to output the integrated memo data and XR content to the user through a display of the host terminal.

17. The operating method of a web-based XR memo and video conferencing system according to claim 13, wherein the step d) includes a step of managing the video data, the XR content, and the memo data received from the host terminal to be stored in the time sequence and if necessary, to be searched and reproduced.

18. The operating method of a web-based XR memo and video conferencing system according to claim 13, further comprising:
a step e) of transmitting the captured synthesized video data to the server to be stored when the synthesized video data including the memo data is captured by a capture interface.
